(19) United States
(12) Patent Application Publication
(10) Pub. No.: US 2007/0135040 A1
(43) Pub. Date: Jun. 14, 2007

(54) Methods for effecting seamless handover and enhancing capacity in elliptical orbit satellite communications systems

(76) Inventor: John E. Draim, Vienna, VA (US)

Correspondence Address: RABIN & Berdo, PC, 1101 14TH STREET, NW, SUITE 500, WASHINGTON, DC, 20005, US

(21) Appl. No.: 11/448,183

(22) Filed: Jun. 7, 2006

Related U.S. Application Data
(60) Provisional application No. 60/749,055, filed on Dec. 12, 2005.

(51) Int. Cl. H04B 7/185

(52) U.S. Cl. 455/12.1

(57) ABSTRACT

Seamless handover of a communications signal from a first satellite to a second satellite is provided when the satellites are at orbital positions which coincide. Timing marks are inserted simultaneously in signals transmitted through the satellites, and signals received from the satellites compared to determine the difference in path length. Handover occurs when the path length difference is zero and the two signals are perfectly synchronized. Interference between the signals transmitted through the two satellites is avoided by using different transmission modes, such as different carrier frequencies, orthogonal senses of polarization, or digital signals with uncorrelated spreading codes. Using these different transmission modes in the right- and left-leaning orbits of a Cobra Teardrop system also permits overlaying multiple teardrop patterns, at longitudinal spacings comparable to the Basic Cobra system, as well as closer in-track spacing of satellites. The result is over an order of magnitude increase in global system capacity.

### RELATED APPLICATIONS

This application claims the benefit of U.S. Provisional Application No. 60/749,055, filed Dec. 12, 2005.

### BACKGROUND OF THE INVENTION

1. Field of the Invention

The invention relates generally to satellite communications systems, and in particular to methods for effecting seamless handover and enhancing capacity in communications systems employing satellites in elliptical orbits.

2. Background Information

It is well recognized that basic two-way global communications with mobile stations, such as ships, aircraft and land vehicles, can be achieved most effectively and reliably using satellite systems. To date, such systems have made exclusive use of satellites in circular orbits, either geostationary (GEO) or low earth orbit (LEO). The major drawbacks for GEO systems (e.g., M-SAT) are their time delay and link margin problems, as well as deficiencies in providing reliable coverage at high latitudes. LEO systems (e.g., Iridium) can provide continuous global plus high-latitude coverage, but on the other hand, require large numbers of satellites.

Medium altitude elliptical-orbit constellations, by contrast, can provide an efficient and affordable alternative to the GEO and LEO satellite architectures. Users of these elliptical orbit constellations would benefit from very high average as well as high minimum elevation angles, resulting in minimal signal attenuation due to atmospheric moisture. Elliptical-orbit systems can provide excellent high- and low-latitude coverage, including polar coverage. Through careful design and selection of their orbital parameters, elliptical arrays can be biased to provide augmented coverage to selected highly populated continental regions. Essentially, coverage is shifted from the lower populated equatorial regions served by GEO satellites to the more highly populated and more attractive market regions at higher latitudes.

Recent developments in elliptical constellations include the Basic Cobra system, described in U.S. Pat. No. 6,701,126, issued Mar. 2, 2004, and the Cobra Teardrop system U.S. Pat. No. 6,714,521, issued Mar. 30, 2004, the disclosures of which are incorporated herein by reference. All of the Cobra satellite systems are designed to avoid interferences with GEO satellites, as well as with each other. The Cobra Teardrop employs time synchronized 8-hour “leaning” elliptical orbits that form two repeating ground tracks. Using only two satellites, there will be one Teardrop pattern active during an 8 hour period in a particular geographic region. With six satellites, properly synchronized, observers in mid-latitude regions will see what appears to be a single satellite orbiting continuously (24 hours per day) almost directly overhead. In reality, the observer at any particular location is seeing six different satellites per day, each for a four hour period while it is in one of its active duty cycles.

A basic six-satellite Cobra Teardrop array, which is shown in FIG. 1, provides simplified satellite tracking by avoiding any need to slew the earth station antenna providing communications with the satellites as one satellite leaves its active arc to be replaced by another satellite entering its active arc. The exchange takes place at the ends of the active arcs of the respective ground tracks, where the satellites are in close proximity. The High-Latitude Handover locations, HLHO-1, HLHO-2, HLHO-3, and the Low-Latitude Handover locations LLHO-1, LLHO-2, LLHO-3, are indicated in FIG. 1. What is needed, however, is a method for executing the handover of a communications signal at these points that is seamless, that is, one that requires little or no electronic buffering or signal storage.

The Basic Cobra system, as described in U.S. Pat. No. 6,701,126, is capable of providing up to a total of 2,880 non-interfering orbit “slots” in the Northern and Southern hemispheres, based on minimum 2 degree spacing between satellites. However, the Cobra Teardrop systems described in U.S. Pat. No. 6,714,521 is limited to a maximum of 576 slots, principally in order to avoid interference that would be caused by the overlapping of adjacent Teardrop patterns. It would be desirable to have a method for seamless handover in the Cobra Teardrop system that also provided the potential to significantly increase the capacity of the Cobra Teardrop system.

### SUMMARY OF THE INVENTION

It is, therefore, a principal object of this invention to provide a method for effecting seamless handover in an elliptical orbit satellite communications system.

It is further object of the invention to provide a method for effecting seamless handover that also enhances the potential capacity of the elliptical orbit satellite communications system.

These and other objects of the present invention are accomplished by the methods for providing seamless handover and enhanced capacity described herein.

In a first aspect of the invention, a method is provided for effecting a seamless handover of a communications signal from a first satellite to a second satellite when the first and second satellites are at orbital positions for which the total path lengths through both satellites are equal, occurring when the satellites are in close proximity at the start or end of their active arcs. The method comprises determining a time at which a first signal path length from a transmitting earth station to a receiving earth station through the first satellite is equal to a second signal path length from the transmitting earth station to the receiving earth station through the second satellite. Seamless communications signal handover is effected when the difference in path length is zero and the signals are perfectly synchronized.

In one embodiment, determination of when the difference in path length is zero is accomplished by inserting a timing mark simultaneously in a first signal transmitted through the first satellite and in a second signal transmitted through the second satellite, receiving the first signal from the first satellite in a first mode; and receiving the second signal from the second satellite in a second mode, such that the second signal does not interfere with the first signal. Handover is performed when the measured time difference between the received timing marks is zero. Interference between the signals transmitted through the two satellites is avoided by using two different transmission modes, such as different carrier frequencies, orthogonal senses of polarization, or spread spectrum signals having uncorrelated spreading codes.

In another embodiment, a precise time for handover is determined by dividing the measured time difference between the two received timing marks, by the rate of change of the time difference. Handover is performed within a few nanoseconds of the predicted time.

These methods for precisely determining the handover time may be used individually or combined, and are particularly applicable to communications signal handovers in Cobra Teardrop systems, where satellites in left-leaning orbits meet satellites in right-leaning orbits while one satellite is leaving its active arc and descending in altitude and the other satellite is entering its active arc and ascending in altitude.

In another aspect of the invention, a simple method is provided for effecting handover of a communications signal from a first satellite which is in a first elliptical orbit and descending in altitude, to a second satellite which is in a second elliptical orbit and ascending in altitude, when the first and second satellites are at orbital positions which coincide. The method comprises determining a time at which the first satellite and the second satellite are at exactly the same altitude, and simultaneously turning the first satellite off and turning the second satellite on at the time so determined. This method may be applied to a Cobra Teardrop array where one of the satellites is in a left-leaning orbit and the other is in a right-leaning orbit. This method can be used where stringent synchronization may not be required, such as in voice communication (telephony).

In a further aspect of the invention, a method is provided for enhancing the communications capacity of a Cobra Teardrop satellite constellation having a first plurality of satellites in a left-leaning ground track and a right-leaning ground track which form a first set of teardrop patterns, and a second plurality of satellites in a left-leaning ground track and a right-leaning ground track which form a second set of teardrop patterns. The method comprises communicating with the satellites in the left-leaning ground tracks using signals in a first mode, communicating with the satellites in the right-leaning ground tracks using signals in a second mode, such that the signals in the second mode do not interfere with the signals in the first mode, and arranging the orbits of the first and second pluralities of satellites such that the first and second sets of teardrop patterns are displaced from each other in longitude but are overlapping. Interference between the signals transmitted through the two satellites is avoided by using two different transmission modes, such as different carrier frequencies, orthogonal senses of polarization, or spread spectrum signals having uncorrelated spreading codes.

### BRIEF DESCRIPTION OF THE DRAWINGS

FIG. 1 is a Cartesian plot of a basic six-satellite Cobra Teardrop array.

FIG. 2 is a perspective view of the Earth showing satellite positions of the basic Cobra Teardrop array at low latitude handovers.

FIG. 3 is a perspective view of the Earth showing satellite positions of the basic Cobra Teardrop array at high latitude handovers.

FIG. 4 illustrates schematically the Cobra Teardrop handover geometry according to the present invention

FIG. 5(a) is a flow chart of a method for determining the time for handover between two satellites according to the present invention.

FIG. 5(b) is a time plot of the time difference ΔT determined according to the present invention.

FIG. 5(c) is a time plot of ΔT-dot, the time rate of change of ΔT, determined according to the present invention

FIG. 5(d) is a time plot of T_{H-O}, the predicted time to handover, determined according the present invention.

FIG. 6 is a Cartesian plot showing the use of overlapping teardrop patterns to enhance Cobra Teardrop system communications capacity according to the present invention.

### DETAILED DESCRIPTION OF THE PREFERRED EMBODIMENTS

The invention will now be described in more detail by way of example with reference to the embodiments shown in the accompanying figures. It should be kept in mind that the following described embodiments are only presented by way of example and should not be construed as limiting the inventive concept to any particular physical configuration.

Further, if used and unless otherwise stated, the terms “upper,” “lower,” “front,” “back,” “over,” “under,” and similar such terms are not to be construed as limiting the invention to a particular orientation. Instead, these terms are used only on a relative basis.

The present invention is directed to methods for effecting seamless handover and enhancing capacity in communications systems employing satellites in elliptical orbits, and in particular, in the Cobra Teardrop system described in U.S. Pat. No. 6,714,521 (the '521 Patent).

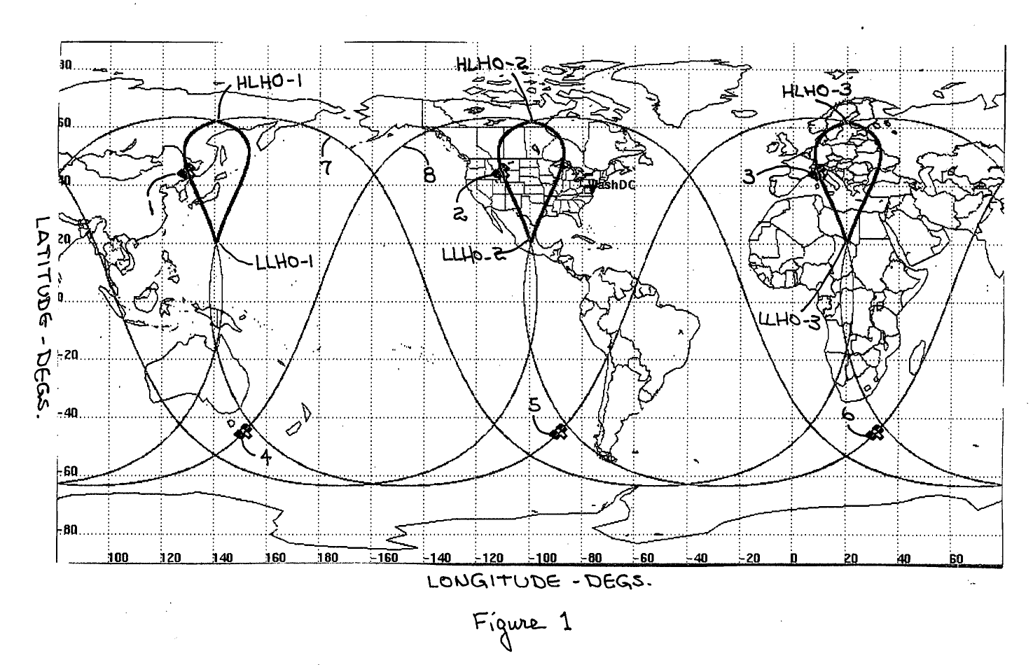

The Cobra Teardrop concept described in the '521 Patent depends on time-coordinated active arcs from multiple satellites. The basic Cobra Teardrop array shown in FIG. 1 consists of six satellites. The orbits of three satellites (1, 2 and 3) are configured to follow a “left-leaning” common ground track 7, while the orbits of the other three satellites (3, 4 and 5) follow a “right-leaning” common ground track 8. The active arcs, which are shown highlighted in FIG. 1, merge at High-Latitude Handover points, HLHO-1, HLHO-2, HLHO-3, and at Low-Latitude Handover points LLHO-1, LLHO-2, LLHO-3, which represent close approaches between two orbits. The orbital elements for the six satellites in the basic Cobra Teardrop array of FIG. 1 are shown in Table I. These elements are a refinement of the Teardrop Array elements given in Table 1 of the '521 Patent. The orbital inclination, i, is changed to more closely match critical inclination, 63.435 degrees, the angle at which the orbit is not perturbed by second-order north-south asymmetries in the shape of the Earth The eccentricity of the orbits, e, is chosen so that the approximate perigee height is 800 km. Given the desired commensurability (3 to 1) between the orbital revolution of the satellite and the rotation of the Earth, the critical inclination, and the assumed eccentricity, the repeat ground-track constraint dictates the mean semi-major axis value. The repeat ground-track algorithm does not depend on the orbits' right ascension of the ascending node, RAAN, argument of perigee, ω, and the mean anomaly, M. The value of these three elements in Table I are unchanged from those in Table 1 of the '521 Patent

In the basic six-satellite Cobra Teardrop array, each satellite has an active-duty cycle of 50%. That is, half the time it is transmitting, and half the time it is silent. The active arcs thus begin and end at satellite mean anomalies of 90 and 270 degrees, respectively. Furthermore, there is a progression of the six satellites day after day, through the three Teardrop patterns shown in FIG. 1. The phasing relationship is

TABLE I
MEAN ORBITAL ELEMENTS
ELLIPTICAL (COBRA) TEARDROP ARRAY
[A BASIC SIX SATELLITE CONSTELLATION PROVIDING
CONTINUOUS CLOSED PATH ANTENNA TRACKING IN
EACH OF THREE GEOGRAPHICAL REGIONS]

| SAT | | | i | RAAN | ω | M |
|---|---|---|---|---|---|---|
| # | a (km) | e | (deg) | (deg) | (deg) | (deg) |
| 1 | 20260.8574 | 0.645714 | 63.435 | 138.5 | 232 | 180 |
| 2 | 20260.8574 | 0.645714 | 63.435 | 18.5 | 232 | 180 |
| 3 | 20260.8574 | 0.645714 | 63.435 | 258.5 | 232 | 180 |
| 4 | 20260.8574 | 0.645714 | 63.435 | 100.2 | 308 | 0 |
| 5 | 20260.8574 | 0.645714 | 63.435 | 340.2 | 308 | 0 |
| 6 | 20260.8574 | 0.645714 | 63.435 | 220.2 | 308 | 0 |

shown, in simplified form, in Table II. Also indicated in Table II are the pairings that occur at the High- and Low-Latitude Handover points (HLHO's and LLHO's). For example, the Table indicates that there is a high latitude handover between satellites 1 and 4, followed by a low-latitude handover between satellites 4 and 3. The same pattern will be repeated for all three Teardrops, but beginning at different times (with roughly 8 hours separation).

TABLE II
Sequence of Satellite Progression in Each Teardrop; Showing Pairings
for High- and Low-Latitude Handovers (HLHO's & LLHO's)

| | | | | | | | |
|---|---|---|---|---|---|---|---|
| Sat# | 1 --------- | 4 --------- | 3 --------- | 6 --------- | 2 --------- | 5 --------- 1 | . . . (repeats) |
| | [symbol] | [symbol] | [symbol] | [symbol] | [symbol] | [symbol] | |
| Type HO | HLHO | LLHO | HLHO | LLHO | HLHO | LLHO | |

The six-satellite Cobra Teardrop constellation described herein has six unique handover points: three at high latitude (HLHO-1, HLHO-2, HLHO-3) and three at low latitude (LLHO-1, LLHO-2, LLHO-3). The three high latitude handovers occur simultaneously and are each associated with particular pairs of the satellites. The same is true for the three low latitude handovers, though the satellite pairs are different and occur at a different time than the high latitude handovers.

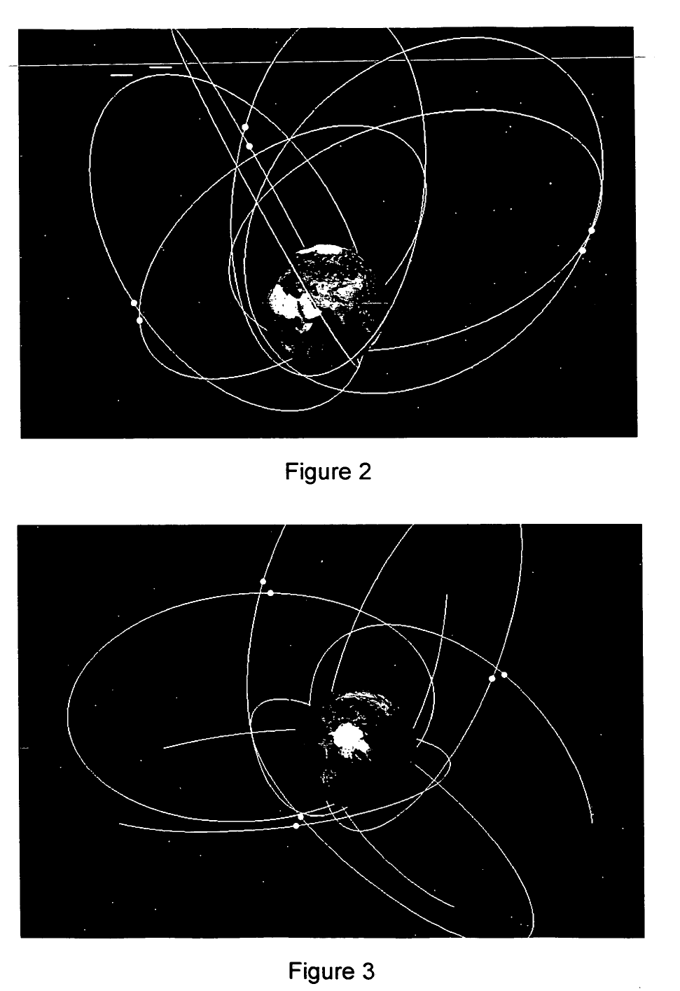

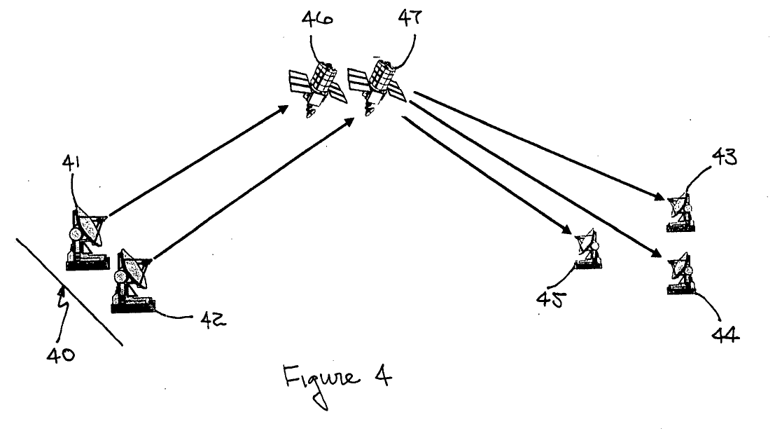

Table III provides some of the basic relationships between the satellite pairs and the handover types. In particular it shows the earth-fixed handover latitudes and longitudes. FIG. 2 shows a three-dimensional view from space of satellite positions at the low latitude handovers. FIG. 3 shows a corresponding three-dimensional view from space of satellite positions at the high latitude handovers. The Figures reflect the fact the fact that there is a slightly larger separation distance between satellites at the low-latitude handovers, than at the high-latitude handovers, for the orbits defined in Table I.

TABLE III
Handover Relationships

| | Satel- | Mean | | | | Altitude |
|---|---|---|---|---|---|---|
| Handover | lite | Anomaly | Latitude | Longitude | Altitude¹ | Rate² |
| Type | Pair | (deg) | (deg. N) | (deg. E) | (km) | (m/sec) |
| High | 1/4 | 270/90 | 62.126 | 260.4 | 20743 | ±1825 |
| Latitude | 2/5 | | | 140.4 | | |
| | 3/6 | | | 20.4 | | |
| Low | 1/5 | 90/270 | 20.386 | 140.4 | 20728 | |
| Latitude | 2/6 | | | 20.4 | | |
| | 3/4 | | | 260.4 | | |

¹The difference between the two altitudes is primarily due to the Earth's ellipsoidal shape
²The satellite pairs have equal, but opposite radial rates

Table IV gives the position and velocity differences at the handovers for the constellation given in Table I. The close approaches have been computed using the Braxton Technologies Astrodynamics Environment (ADE) space flight dynamics software (described in Astrodynamics Environment (ADE): An Alternative Approach to Space Flight Dynamics Software, AAS05-403, AAS/AIAA Astrodynamics Specialist Conference, August 2005, Lake Tahoe, Nev.). The Table shows the larger position difference at the LLHO points, which was noted above. With further orbital design refinements, the LLHO separation can be reduced to be roughly equal in value to the HLHO separation—or about 50 km.

TABLE IV
HANDOVER POSITION AND VELOCITY DIFFERENCES
ELLIPTICAL (COBRA) TEARDROP ARRAY

| HLHO's | | |
|---|---|---|
| Delta Position | 47.4928 | km |
| Delta Velocity | 3.9369 | km/sec |
| LLHO's | | |
| Delta Position | 155.6685 | km |
| Delta Velocity | 5.7579 | km/sec |

The altitude rates at the handover points are such that the arriving satellite (i.e., the one that is handed over to) has increasing altitude (ascending) while the departing satellite (i.e., the one from which handover occurs) has decreasing altitude (descending). Since the satellites are at symmetric locations in the orbital ellipse (i.e., 90° and 270° mean anomalies), the radial velocities (\dot{r}) are equal, but opposite and may be approximated using the simple two-body orbital equation:

$$\dot{r} = e \cdot sin θ \sqrt{\frac{μ}{a ( 1 - {e}^{2} )}} \qquad ( 1 )$$

where α is the major axis, e is the ellipticity, θ is the mean anomaly and μ is the product of G, the universal gravitation constant, and Mₑ, the mass of the Earth, and has a value of 398,600.5 km³/sec².

Applying this formula to the basic Cobra Teardrop constellation, the value for r-dot at the 90° and 270° mean anomaly positions are ±1.825 km/sec respectively. Since r itself is measured from the center of the earth, these are the values for rate of change of altitude as well.

The realization of the Cobra constellation geometry requires the generation of two unique sets of repeating ground tracks: left-leaning and right leaning. Satellites 1, 2, and 3 are in the left-leaning ground tracks and their counterparts 4, 5, 6 are in the right leaning ground tracks. However, since the ground tracks fly over different areas of the Earth's surface, they are subjected to different resonant tesseral gravitational perturbations and thus over time will not maintain exactly the same relationship. A slow secular drift is, in fact, apparent over time that will necessitate the use of station-keeping maneuvers.

At the handover points the satellites are physically in very close proximity. Theoretically, a perfectly designed Teardrop array would result in physical collisions between the arriving and departing satellites. In order to avoid this catastrophic outcome, it has been determined that there should be a roughly 25-75 km separation maintained between arriving and departing satellites at the handover points. There are a variety of ways that this can be accomplished through slight adjustments of the orbital parameters. The most obvious method involves shifting one satellite's RAAN by a small amount. Another method would be to use a slightly different eccentricity for each satellite. The satellite beginning its active duty cycle (the arriving satellite) is ascending (towards apogee), while the satellite about to end its active service (the departing satellite) is descending (towards perigee). This favorable geometry can be utilized to execute a seamless handover (i.e., not requiring electronic buffering) from one satellite to the other.

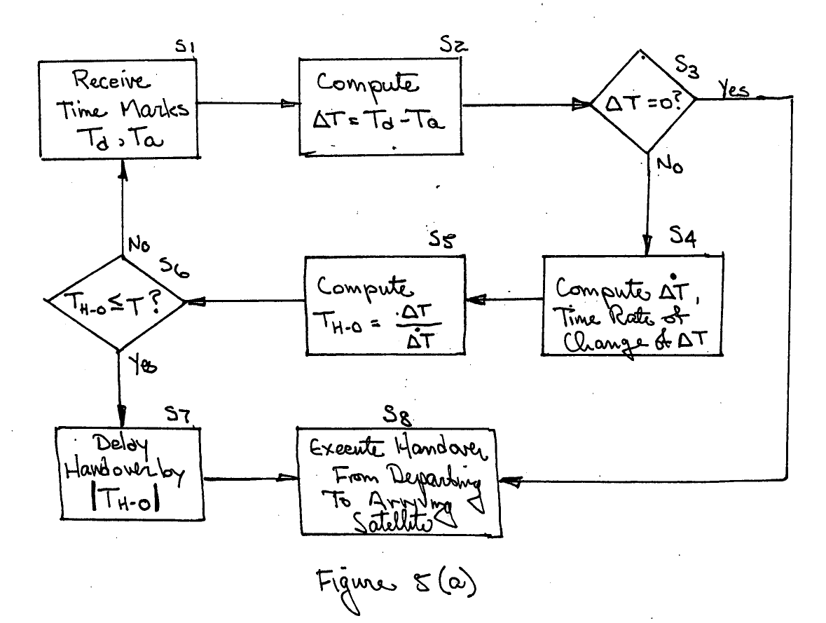

FIG. 4 depicts the basic geometry of a master earth station 40 with two antennas 41, 42, a number of mobile user earth stations 43, 44, 45, and two satellites 46, 47 at a handover point. The master earth station is capable of transmitting to and receiving from both satellites when they are in the vicinity of the handover point. At the handover point, the two satellites are at nearly the same location providing virtually the same line of sight for the mobile user earth stations, which only have one antenna for receiving and transmitting The satellite handing over 46 is descending in altitude while the satellite accepting handover 47 is ascending in altitude.

A relatively straightforward approach to seamless handover is to execute the handover when both the satellites are at the same altitude. This could be done by simply turning off transmissions from the departing satellite at the same instant that the arriving satellite starts transmissions. This will be designated as Option 1. Since the satellites will both be seen at a high elevation angle, the total signal path lengths will be approximately the same for both satellites. This simple solution allows for both satellites, at the same altitude and latitude, with a small longitudinal offset, to use the same frequency and polarization for communications without interfering. It should also be noted that the bisector plane, of the line connecting the two satellites at this point, intersects the Earth's surface along meridians of longitude (as well as the center of the earth), assuming the satellites were at exactly the same altitude and latitude. If either or both of the master station and a mobile user are not on this meridian, the total path length through one satellite would be slightly different than the total path length through the other satellite. While this option may prove perfectly satisfactory for some communications applications such as voice telephony, it may not satisfy other more exacting requirements where high data rate is combined with stringent bit-error requirements. Alternate handover schemes for meeting these types of requirements will be considered next.

In order to execute the handover at exactly the right instant for all transmitter and receiver locations on the Earth's surface, it will be necessary to execute the handover when the total communications path lengths are exactly equal through each of the satellites. A method for determining within a few nanoseconds when this occurs must be used. Since there will be slightly different geometries for different users, a brief overlap in downlink signal transmissions around the handover time will be required. This, in turn, will require a means for discriminating between the two satellites' signals while both satellites are transmitting. Three of the possible methods (numbered options) for accomplishing this discrimination are:
Option 2: Having each satellite downlink operate at a different RF frequency.
Option 3: Using right-hand versus left-hand circular polarization, for right-leaning versus left-leaning satellites, with the same frequency, and
Option 4: Using CDMA or WCDMA with different spreading codes to differentiate the right-leaning from the left-leaning satellites, again at the same RF frequency.

In order to determine the exact instant that the total path-lengths through both satellites are the same, a sequence of timing pulses could be inserted simultaneously by the transmitting station into the communications signals through both satellites. At the instant that the path lengths are equal, the timing pulses for both satellites will be received simultaneously, and the bit streams of data through the two satellites will be synchronized. For this technique, the mobile user earth stations as well as the master earth station must be capable of receiving the non-interfering signals from both satellites.

It has been determined that in order to avoid ambiguities in measuring the path length difference, the interval between the transmitted timing pulses should be on the order of 800 microseconds, which is equivalent to a 240 km difference in path length. At the difference in velocity of 5.75 kin/sec. at the LLHO's (see Table IV), it will take the two satellites approximately 42 seconds to decrease their separation by 240 km. Approximately 30 seconds of signal overlap on either side of the handover times should be sufficient to provide an unambiguous determination by downlink receivers of the correct instant to execute handover, to within a few nanoseconds, for any possible geographical locations of transmitting and receiving stations.

Because the path length difference measurement occurs at intervals that may not coincide precisely with the instant at which the path length difference actually passes through zero, it may be desirable to employ a handover-time-predictor at the earth stations that calculates when the path lengths will be equal by dividing the time difference between arrivals of the leading edges of the timing pulses, by the rate of change of these time differences. In this manner, the time remaining until path lengths are equal would be determined. At the precise instant that the path lengths are predicted to become equal, the necessary handover is executed, using for example, one of the three methods previously discussed (Option 2, 3, or 4).

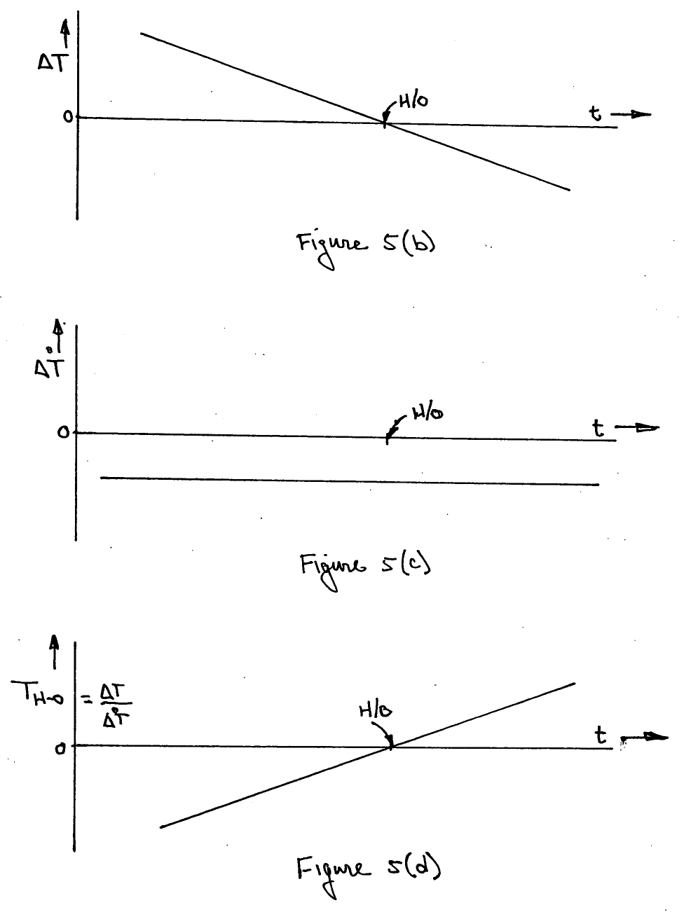

FIG. 5(a) illustrates the above described methods for determining the exact instant for handover. The process starts at step 1 approximately 30 seconds before the time that the two satellites are expected to be at the same altitude, as noted above. (Current state of the art orbit determination technology permits prior calculation of the time at which the altitudes will be equal to within 2 seconds.) In step S1, time marks Tₐ and T_{d} are received through the arriving and departing satellites, respectively. In step S2 the time difference ΔT, between T_{d} and Tₐ, is computed. In the event ΔT equals zero at step S3, then the process goes directly to handover at step S8, otherwise it proceeds to step S4. In step S4, ΔT-dot, the time rate of change in ΔT from the last calculation, is determined. In step S5, T_{H-O}, the time remaining to handover, is calculated by dividing ΔT by ΔT-dot In step S6, T_{H-O} is compared to the interval between transmitted time marks, T. If T_{H-O} is less than or equal to T, then the handover from the communications signal on the departing satellite to the communications signal on the arriving satellite is scheduled to be performed (step S8) after a delay of T_{H-O} (step S7). On the other hand, if T_{H-O} is greater than T, meaning that ΔT will not be going through zero in then next measurement interval, then the process returns to step S1 to await the arrival of the next set of received Tₐ and T_{d} timing marks. At least two measurements of ΔT before handover are necessary for the calculation of ΔT-dot.

FIG. 5(b) is a time plot of ΔT showing the handover point, H/O, at which time ΔT goes from positive to negative through zero. FIG. 5(c) is a time plot of ΔT-dot, which is the slope of the ΔT plot and has an essentially constant negative value in the vicinity of H/O. FIG. 5(d) is a time plot of T_{H-O}, which goes from negative to positive through zero at H/O. The process in FIG. 5(a) essentially ignores negative values of ΔT and positive values of T_{H-O}, both of which occur after handover at the receiving terminal in question. As suggested earlier, transmission of timing pulses may continue for a short time thereafter to assure that seamless handover takes place at all affected receiving stations.

The fortuitous geometry existing between the elliptic-orbit Cobra Teardrop satellites at the handover points permits a seamless handover requiring little or no electronic buffering or memory storage. The simplest option involves commencement/termination of signals from the two satellites involved at the precise instant that their altitudes match. The other three more precise options described in this application involve calculation of the exact instant of time (within a few nanoseconds) that the total path-lengths between transmitting and receiving stations are equal.

Using the simplest method with satellites having the same operating frequency and polarization, and without CDMA or any other method for avoiding interference between carriers, and with satellites requiring a minimum of 2° spacing—only twelve Teardrop patterns per hemisphere can be supported. Due to cusping at the low-latitude handover points, each active arc can actually only support a maximum of 12 satellites, for a total of 24 satellites per Teardrop. Thus, there can be 12×24=288 slots per hemisphere, or a total of 576 slots for both the Northern Hemisphere and the Southern Hemisphere. The number of available slots is limited in the basic Cobra Teardrop system because there can be no overlays of the Teardrop patterns themselves when the same frequency and polarization are used for all satellites.

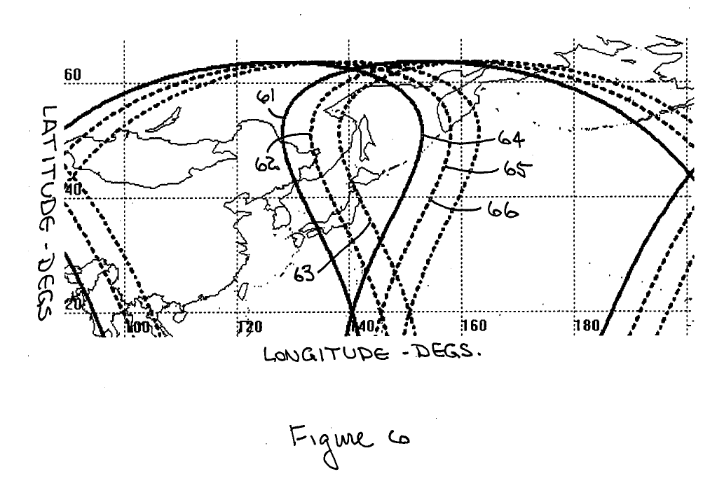

If, on the other hand, one of the more precise seamless handover methods described above (such as Options 2, 3, or 4) were used, there would be no interference between right-leaning and left-leaning satellites, and there would be no problem in having the Teardrop patterns, which are formed by the active arcs of the left- and right-leaning ground tracks, overlap. FIG. 6 illustrates an exemplary system in which there are three overlapping Teardrop patterns where the left-leaning ground tracks 61, 62, 63 (and correspondingly the right-leaning ground tracks 64, 65, 66) are spaced together as closely as in the Basic Cobra system. Accordingly, any of the alternatives for avoiding interference and assuring seamless handover would allow for 20 slots per active arc, the full number available in the Basic Cobra system, or 40 slots per Teardrop. This results in 40×72=2,880 slots per hemisphere with a minimum of 2° satellite separation, or 5,760 available satellite slots for both Northern and Southern Hemispheres (i.e., complete global coverage).

Given that the GEO ring is presently saturated at approximately 180 slots (360°/2°), these new elliptical arrays, with over an order of magnitude increase in the number of slots compared with GEO, should be able to satisfy the world's satellite communications capacity requirements through most of the next century.

It should be understood that the invention is not necessarily limited to the specific process, arrangement, materials and components shown and described above, but may be susceptible to numerous variations within the scope of the invention For example, although the above-described exemplary aspects of the invention are believed to be particularly well suited to the Cobra Teardrop system, whose satellites have 8-hour orbits, the inventive methods can also be applied to any other system of communication satellites in elliptical orbits that repeats an integral number (e.g., Molniya, 2 revolutions per day) or an integral fractional number (e.g., 3.5, or 7 revolutions every 2 days) of times each day.

It will be apparent to one skilled in the art that the manner of making and using the claimed invention has been adequately disclosed in the above-written description of the preferred embodiments taken together with the drawings.

It will be understood that the above description of the preferred embodiments of the present invention are susceptible to various modifications, changes and adaptations, and the same are intended to be comprehended within the meaning and range of equivalents of the appended claims.

What is claimed is:

1. A method for effecting a seamless handover of a communications signal from a first satellite to a second satellite when the first and second satellites are at orbital positions which coincide, the method comprising:
determining a time at which a first signal path length from a transmitting earth station to a receiving earth station through the first satellite is equal to a second signal path length from the transmitting earth station to the receiving earth station through the second satellite; and
effecting the communications signal handover from the first satellite to the second satellite at the time so determined.

2. The method of claim 1, wherein said determining a time at which the first and second signal path lengths are equal comprises:
inserting a timing mark simultaneously in a first signal transmitted through the first satellite and in a second signal transmitted through the second satellite;
receiving the first signal from the first satellite in a first mode; and
receiving the second signal from the second satellite in a second mode, such that the second signal does not interfere with the first signal.

3. The method of claim 2, wherein the first mode is transmission at a first carrier frequency and the second mode is transmission at a second carrier frequency which differs from the first carrier frequency.

4. The method of claim 2, wherein the first mode is transmission in a first polarization sense and the second mode is transmission in a second polarization sense which is orthogonal to the first polarization sense.

5. The method of claim 4, wherein one of the first and second polarization sense is right-hand circular polarization and the other polarization sense is left-hand circular polarization.

6. The method of claim 2, wherein the first mode is spread spectrum digital transmission using a first spreading code and the second mode is spread spectrum digital transmission using a second spreading code which is uncorrelated with the first spreading code.

7. The method of claim 2, wherein said determining a time at which the first and second signal path lengths are equal further comprises:
measuring a time difference between receipt of the time mark inserted in the first signal and receipt of the time mark inserted in the second signal; and
determining the first and second signal path lengths to be equal when the time difference is zero.

8. The method of claim 2, wherein said determining a time at which the first and second signal path lengths are equal further comprises:
measuring a time difference between receipt of the time mark inserted in the first signal and receipt of the time mark inserted in the second signal;
determining a rate of change of the time difference based on the measurement of the time difference and at least one previous measurement of the time difference;
dividing the measured time difference by the rate of change of the time difference to predict when the first and second signal path lengths will be equal

9. The method of claim 1, wherein both the first satellite and the second satellite are in elliptical orbits.

10. The method of claim 9, wherein one of the first satellite and the second satellite is in a left-leaning Cobra Teardrop orbit and the other is in a right-leaning Cobra Teardrop orbit.

11. The method of claim 9, wherein the first satellite in descending in altitude and the second satellite is ascending in altitude.

12. The method of claim 9, wherein the first satellite is turned off after handover of the communications signal and the second satellite is turned on before handover of the communications signal.

13. A method for effecting handover of a communications signal from a first satellite which is in a first elliptical orbit and descending in altitude, to a second satellite which is in a second elliptical orbit and ascending in altitude, when the first and second satellites are at orbital positions which coincide, the method comprising:
determining a time at which the first satellite and the second satellite are at the same altitude; and
simultaneously turning the first satellite off and turning the second satellite on at the time so determined.

14. The method of claim 13, wherein one of the first satellite and the second satellite is in a left-leaning Cobra Teardrop orbit and the other is in a right-leaning Cobra Teardrop orbit.

15. A method of enhancing the communications capacity of a Cobra Teardrop satellite constellation having a first plurality of satellites in a left-leaning ground track and a right-leaning ground track which form a first set of teardrop patterns, and a second plurality of satellites in a left-leaning ground track and a right-leaning ground track which form a second set of teardrop patterns, the method comprising:
communicating with the satellites in the left-leaning ground tracks using signals in a first mode;
communicating with the satellites in the right-leaning ground tracks using signals in a second mode, such that the signals in the second mode do not interfere with the signals in the first mode; and
arranging the orbits of the first and second pluralities of satellites such that the first and second sets of teardrop patterns are displaced from each other in longitude but are overlapping.

16. The method of claim 15, wherein the first mode is transmission at a first carrier frequency and the second mode is transmission at a second carrier frequency which differs from the first carrier frequency.

17. The method of claim 15, wherein the first mode is transmission in a first polarization sense and the second mode is transmission in a second polarization sense which is orthogonal to the first polarization sense.

18. The method of claim 17, wherein one of the first and second polarization sense is right-hand circular polarization and the other polarization sense is left-hand circular polarization.

19. The method of claim 15, wherein the first mode is spread spectrum digital transmission using a first spreading code and the second mode is spread spectrum digital transmission using a second spreading code which is uncorrelated with the first spreading code.
